(19) United States
(12) Patent Application Publication
(10) Pub. No.: US 2016/0335587 A1
(43) Pub. Date: Nov. 17, 2016

(54) REMAINS CONTAINER MANAGEMENT

(71) Applicant: William A. Taylor, Greer, SC (US)

(72) Inventor: William A. Taylor, Greer, SC (US)

(21) Appl. No.: 14/713,732

(22) Filed: May 15, 2015

(51) Int. Cl. G06Q 10/08; G01S 19/13; G06Q 20/14; A61G 17/08

(52) U.S. Cl. CPC G06Q 10/087; A61G 17/08; G01S 19/13; G06Q 20/14

(57) ABSTRACT

A computer-implemented method for managing an inventory of remains containers, such as caskets, is provided. The method includes registering, by one or more computing devices, an electronic tag configured to he attached to a remains container and receiving, by one or more computing devices, status information from the electronic tag once the electronic tag is attached to the remains container. The status information may include a location of the electronic tag and the remains container to which it is attached. The method also includes determining, by one or more computing devices, a status of the remains container based at least in part on the received status information from the electronic tag or a cessation of received status information from the electronic tag.

### FIELD OF THE INVENTION

The present invention relates generally to a system and method for managing an inventory of remains containers to be provided to one or more consignees.

### BACKGROUND OF THE INVENTION

It is a common practice in the industry of casket manufacturing for a casket manufacturer to provide one or more caskets of an inventory of caskets to one or more parties (i.e., consignees) on consignment. These consignees are typically funeral homes or distributors. With such an arrangement, the one or more consignees typically pay little or no cost upfront for the caskets and instead pay the casket manufacturer once, e.g., a casket has been sold or after predetermined amount of time has passed. For example, a consignee may receive a plurality of caskets from a casket manufacturer on consignment and display such caskets in a parlor or other display area, A. customer may then pick out a desired casket from the consignee and pay the consignee for the casket. The consignee should then, in turn, pay the casket manufacturer for the casket.

Depending on the size of the casket manufacturer, such manufacturer may have a relatively large amount of caskets divided up between a multitude of different consignees. Accordingly, in such a case it may be difficult for the casket manufacturer to keep track of each casket provided to the variety consignees. Moreover, in practice certain consignees are less diligent than others in notifying the casket manufacturer of a sale of one or more of the caskets provided on consignment.

Therefore, an improved system and method for managing an inventory of caskets or other remains containers provided to one or more consignees would be beneficial. More particularly, a system and method for notifying the casket manufacturer once a casket has been sold would be particularly useful,

### BRIEF DESCRIPTION OF THE INVENTION

Aspects and advantages of the invention are set forth below in the following description, or may be obvious from the description, or may be learned through practice of the invention.

In a first exemplary aspect of the present disclosure, a computer-implemented method for managing an inventory of remains containers is provided. The method includes registering, by one or more computing devices, an electronic tag configured to he attached to a remains container and receiving, by one or more computing devices, status information from the electronic tag once the electronic tag is attached to the remains container. The method also includes determining, by one or more computing devices, a status of the remains container based at least in part on the received status information from the electronic tag or a cessation of received status information from the electronic tag.

In a second exemplary aspect of the present disclosure, a computer-implemented method for managing an inventory of remains containers is provided. The method also includes registering, by one or more computing devices, an electronic tag configured to be attached to a remains container and receiving, by one or more computing devices, status information from the electronic tag once the electronic tag is attached to a remains container for a consignee. Additionally, the method includes determining, by one or more computing devices, a cessation of received status information from the electronic tag and determining, by one or more computing devices, a billing event has occurred in response to the determination of a cessation of received status information from the electronic tag.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 provides a side view of a casket according to an exemplary aspect of the present disclosure.

FIG. 2 provides a schematic diagram of a system for managing an inventory of remains containers in accordance with an exemplary aspect of the present disclosure.

FIG. 3 provides a flow diagram illustrating a computer-implemented method for managing an inventory of remains containers in accordance with an exemplary aspect of the present disclosure.

FIG. 4 provides a flow diagram illustrating a computer-implemented method for managing an inventory of remains containers in accordance with another exemplary aspect of the present disclosure.

### DETAILED DESCRIPTION OF THE INVENTION

Reference now will he made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In certain aspects of the present disclosure, a method for managing an inventory of remains containers, such as caskets or urns, is provided. For example, in one exemplary aspect, the method includes providing certain information about an electronic tag to a computing device. The information provided about the electronic tag may include, for example, an identification number of the electronic tag. The exemplary method also includes attaching the electronic tag to a remains container and providing the remains container, with the electronic tag attached thereto, to a consignee. The electronic tag communicates information with the computing device and the method determines certain information about the remains container based at least in part on the information communicated between the electronic tag the computing device.

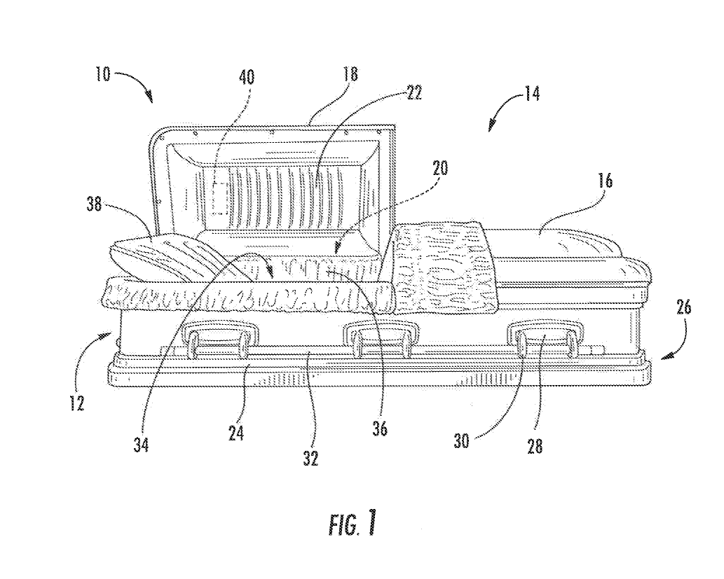

Referring now to the Figures, FIG. 1 provides a front view of a remains container in accordance with an exemplary embodiment of the present disclosure. More particularly, for the embodiment of FIG. 1, the remains container is a casket 10. The exemplary casket 10 generally includes a body 12 and a top 14. The top 14 is divided into a first lid 16 and a second lid 18. The first lid 16 is shown in a closed position in the second lid 18 is shown in an open position. The first and second lids 16, 18 may each be attached to the body 12 of the casket 10 by one or more hinge assemblies 20 (shown in phantom). An interior panel 22 covers an inside portion of the second lid 18, as shown. The interior panel 22 is typically made of a soft fabric material.

The body 12 of the casket 10 includes base molding 24 extending around a perimeter of a bottom portion 26 of the casket 10. Additionally, the casket 10 includes a plurality of lugs 28 attached to the body 12 of the casket 10 and spaced around the perimeter of the casket 10. The lugs 28 each include one or more arms 30 attaching the lugs 28 to a respective handle 32. The handles 32 may be used during, e.g., transportation of the casket 10.

The body 12 of the casket 10 defines an interior compartment 34 configured to receive a body of a deceased. The interior compartment 34 is closed when the first and second lids 16, 18 are in a closed position and the interior compartment 34 is exposed when the first lid 16 and/or second lid 18 are in the open position (as shown). The interior compartment 34 is lined with a fabric lining 36 and/or pillow-type material. Moreover, for the embodiment depicted, a pillow 38 is provided within the interior compartment 34.

As is discussed in greater detail below, the exemplary casket 10 of FIG. 1 additionally has an electronic tag 40 (shown in phantom) attached thereto in a manner such that the tag 40 is hidden from view, More particularly, for the embodiment of FIG. 1, the casket 10 includes the electronic tag 40 positioned between the interior panel 22 and the second lid 18. It should be appreciated, that as used in herein with reference to the electronic tag 40, the term “attached” means generally that the electronic tag 40 is not easily separated from the casket 10 or other remains container. For example, as used herein, attaching the electronic tag 40 to the casket 10 may include welding, soldering, or otherwise affixing the electronic tag 40 to a surface of the casket 10, or alternatively simply placing the electronic tag 40 in an enclosed area of the casket 10.

Accordingly, it should be appreciated that in other exemplary embodiments, the electronic tag 40 may be attached in any other suitable location of the casket 10. For example, in other exemplary embodiments, the electronic tag 40 may be positioned in an opening of the handle 32, affixed to an inside surface of the base molding 24, placed between the one or more of the lugs 28 and the body 12 of the casket 10, placed between the lining 36 and the body 12 of the casket 10, or otherwise attached in any other suitable location. Additionally, it should be appreciated that in other exemplary embodiments, the exemplary casket 10 depicted in FIG. 1 may have any other suitable configuration, may not include one or more of the features described herein, or may include additional features not described herein. Additionally, or alternatively, the remains container may not be a casket 10, and instead the remains container may be any other container for receiving a body of a deceased person or animal. For example, the remains container may alternatively be an urn.

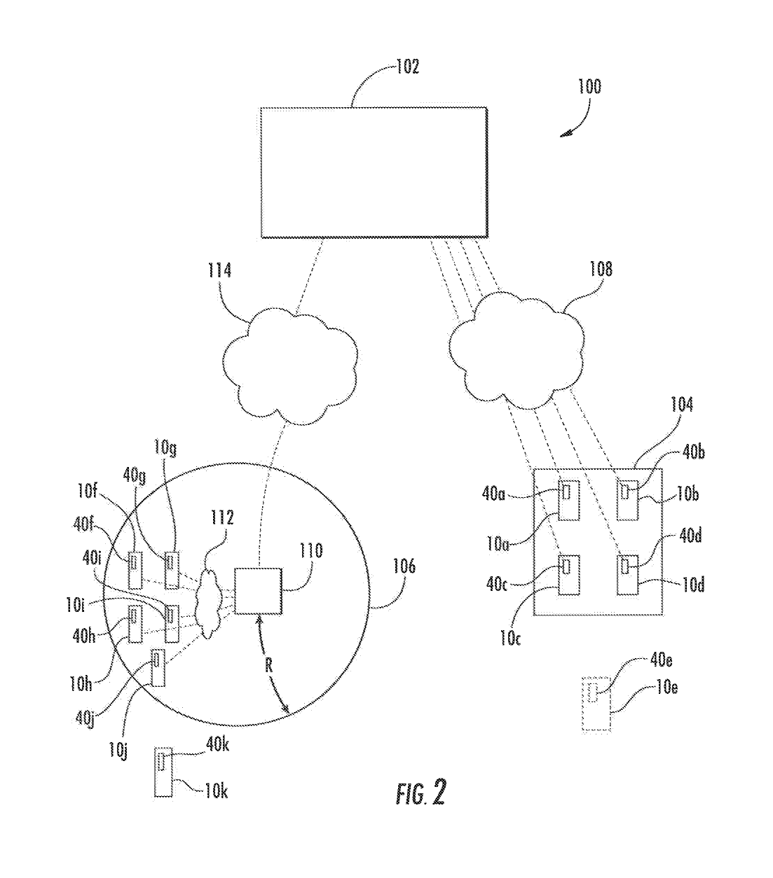

Referring now to FIG. 2, a system 100 for managing an inventory of remains containers, such as caskets 10, is provided. The exemplary system 100 generally includes a computing device 102 which, as will be described in greater detail below, is capable of receiving status information from the one or more electronic tags 40. It should be appreciated that as used herein the term “computing device” refers generally to a device or a plurality of devices having one or more processors and memory and being capable of processing data. The computing device 102 may, for example, be what is commonly referred to as a computer, such as a laptop computer, desktop computer, smartphone, tablet, or any other type of computer, Additionally, the computing device 102 may include for example one or more user interface devices, such as a display screen, a keyboard, a mouse, a touch screen display, or any other user interface device. Further, the computing device 102 may include, for example, one or more computing devices and/or a central server. In such an embodiment, the central server may be configured to exchange data with the one or more computing devices over a network, such as a local area network (“LAN”) or a wide area network (“WAN”).

For the embodiment of FIG. 2, one or more caskets 10 have been provided to one or more consignees on consignment. More particularly, eleven (11) caskets 10a-10k have been provided on consignment to a first consignee 104 and a second consignee 106, it being understood that in other embodiments, any other suitable number of caskets 10 may be provided to any other suitable number of consignees. Additionally, as used herein, the term “consignment” refers generally to a business transaction wherein an owner of an item provides a party (i.e., a consignee) such item without being owed full consideration for the item upon transfer of the item. Instead, the owner and consignee typically have negotiated a payment structure wherein, e.g., the owner is owed full consideration after the item is sold or after a predetermined amount of time.

Each of the eleven caskets 10a-10k include electronic tags 40a-40k, respectively. Each tag 40a-40k may be configured to communicate status information with the computing device 102 through a communication network, More particularly, tags 40a-40e attached to caskets 10a-10e provided to first consignee 104 are configured to communicate status information with the computing device 102 through a communication network 108. Additionally, as will he explained in greater detail below, tags 40f-40k attached to caskets 10f-10k provided to the second consignee 106 are configured to communicate status information with a local hub 110 via a first communication network 112 and the local hub 110 is configured to communicate such information with computing device 102 via a second communication network 114. Networks 108, 112, and 114 may each be wireless communications networks or a combination of wired and wireless communication networks. For example, in certain exemplary embodiments, networks 108, 112, and 114 may be a wired and/or wireless LAN (such as an intranet), WAN (such as the Internet), cellular data communications networks, mobile satellite communications networks, wireless sensor networks (such as Bluetooth), point-to point communication networks (such as radio frequency identification networks, near field communications networks, etc.), or a combination of two or more of the above communications networks. Communication between the computing device 102, the one or more electronic tags 40, and the local hub 110 (if provided) via networks 108, 112, and/or 114 can generally be carried out using a variety of communication protocols (e.g. TCP/IP, HTTP, SMTP, FTP), encodings or formats (e.g. HTML, XML), and/or protection schemes (e.g. VPN, secure HTTP, SSL).

Accordingly, as used herein, the term “electronic tag” refers to any device that includes, e.g., cellular technology, Bluetooth transmitters and/or receivers, radiofrequency identification tags, or other hardware enabling the device to communicate status information through a communication network. Further, in certain exemplary embodiments, one or more of the electronic tags 40 may additionally include hardware or software for determining an actual geographic position of the electronic tag 40. For example, in certain exemplary embodiments, one or more of the electronic tags 40 may include a Global Positioning System (“GPS”) receiver for determining its actual geographic location using a GPS network.

For the exemplary system 100 provided in FIG. 2, the electronic tags 40a-40e attached to the respective caskets 10a-10e provided to the first consignee 104 are each configured to communicate information directly with the computing device 102 through communications network 108. Accordingly, the network 108 may be, for example, a cellular communications network, a satellite communications network, or other communications network capable of relatively long range communications. Additionally, each of the electronic tags 40a-40e may include hardware and/or software enabling the electronic tags 40a-40e to communication information with the computing device 102 through such network 108.

Each of the electronic tags 40a-40e also include a UPS receiver configured to determine its actual location using the UPS network, The electronic tags 40a-40e may therefore determine their actual locations (using the UPS receiver) and communicate such locations to the computing device 102 through the network 108. Such a communication may be in response to a user input to the computing device 102, or alternatively according to a predetermined schedule.

When one or more the caskets 10, such as casket 10e (shown in phantom in FIG. 2), is selected and purchased by a customer of the consignee 104, that casket 10e is typically moved away from a central location 116 of the first consignee 104 (or an “anticipated location” of the casket 10e). The casket 10e may then be buried such that the electronic tag 40e may no longer be capable of communicating status information with the computing device 102 through the network 108 and/or the UPS receiver may no longer be capable of determining an actual location of the tag 40e through the GPS network. Such a cessation of communications ability may be a result of the electronic tag 40e and casket 10e being buried below ground.

Alternatively, even if the electronic tag 40e is capable of determining its actual location using the GPS receiver and communicating such status information with the computing device 102 after being moved away from the central location 116 of the first consignee 104, the actual location of the tag 40e and casket 10e will not match the anticipated location of the tag 40e and casket 10e. For the embodiment depicted, the anticipated location of the casket 10e is the same as the central location 116 of the first consignee 104. However, in other exemplary embodiments, the anticipated location may be any other suitable location at which it may be presumed the casket 10e has not be sold to a customer.

In response to a cessation of the electronic tag 40e communicating status information with the computing device 102, the GPS receiver no longer being capable of communicating with the GPS network, and/or the actual location of the tag 40e and casket 10e no longer being equal to the anticipated location of the tag 40 and casket 10, the computing device 102 may automatically determine a billing event has occurred. The computing device 102 may then automatically generate an invoice for the casket 10e and send such invoice to the consignee 104.

Referring still to the exemplary system 100 of FIG. 2, the electronic tags 40f-40k attached to the caskets 10f-10k provided to the second consignee 106 are also in communication with the computing device 102 through one or more communications networks. More particularly, for the embodiment depicted, each of the electronic tags 40f-40k attached to the caskets 10f-10k provided to the second consignee 106 are in communication with the local hub 110 through the first communications network 112, and the local hub 110 is in communication with the computing device 102 through the second communications network 114. The first communications network 112 may be, for example, a wireless sensor network (such as Bluetooth), a point-to point communication network (such as a radio frequency identification network, near field communications network, etc.), or other communications network capable of communicating information over relatively short distances. Additionally, the second communications 114 network may be a WAN, LAN, or other communications network capable of communicating information over relatively long distances.

As is depicted, the local hub 110 may be positioned within a predetermined range R of the electronic tags 40f-40k attached to respective caskets 10f-10k provided to the second consignee 106. This predetermined range R may be equal to an approximate range of communication capable between the local hub 110 and the electronic tags 40f-40k attached to the respective caskets 10f-10k through the first communications network 112. Such a configuration may allow for the system 100 to determine an actual location of each of the electronic tags 40f-40k attached to respective caskets 10f-10k. The actual location of each of these electronic tags 40f-40k and caskets 10f-10k may be an actual distance from the local huh 110. Additionally, with such a configuration, the system may set an anticipated location for each of the electronic tags 40f-40k and caskets 10f-10k. For the embodiment depicted, the anticipated location for each of the electronic tags 40f-40k and caskets 10f-10k may be a distance less than or equal to the predetermined range of communication capable between the local hub 110 and the electronic tags 40f-40k over the network 112, The system 100 may presume that if the caskets 10f-10k are within the predetermined range of communication, the caskets 10f-10k are likely to be, e.g., on display or in storage.

Moreover, the exemplary system 100 of FIG. 2 may similarly determine a billing event has occurred when the system 100 determines that the actual location of one or more of the electronic tags 40f-40k and caskets 10f-10k is not equal to an anticipated location of such electronic tags 40f-40k and caskets 10f-10k. For example, in the embodiment of FIG. 2, the actual locations of caskets 10f-10j are equal to the anticipated locations of the caskets 10f-10j. By contrast, however, the actual location of the casket 10k is not equal to the anticipated location of casket 10k. Accordingly, the system 100 may determine a. billing event has occurred with respect to casket 10k.

Alternatively, the exemplary system 100 of FIG. 2 may determine a billing event has occurred in response to a cessation of receipt of information from the electronic tag 40. More particularly, the exemplary system 100 may determine a billing event has occurred when the electronic tag 40 is no longer capable of communicating information with the local hub 110. For example, the exemplary system 100 may determine a billing event when the electronic tag 40k is outside the predetermined range R of the local hub 110 or otherwise obstructed from communicating information with the local huh 110 over the network 112 (e.g., when the casket 10k is buried).

It should be appreciated, however, that the system 100 described with reference to FIG. 2 is by way of example only. In other exemplary embodiments of the present disclosure, the system 100 may only use one type of electronic tag 40 with each of a plurality of caskets 10 provided to various consignees.

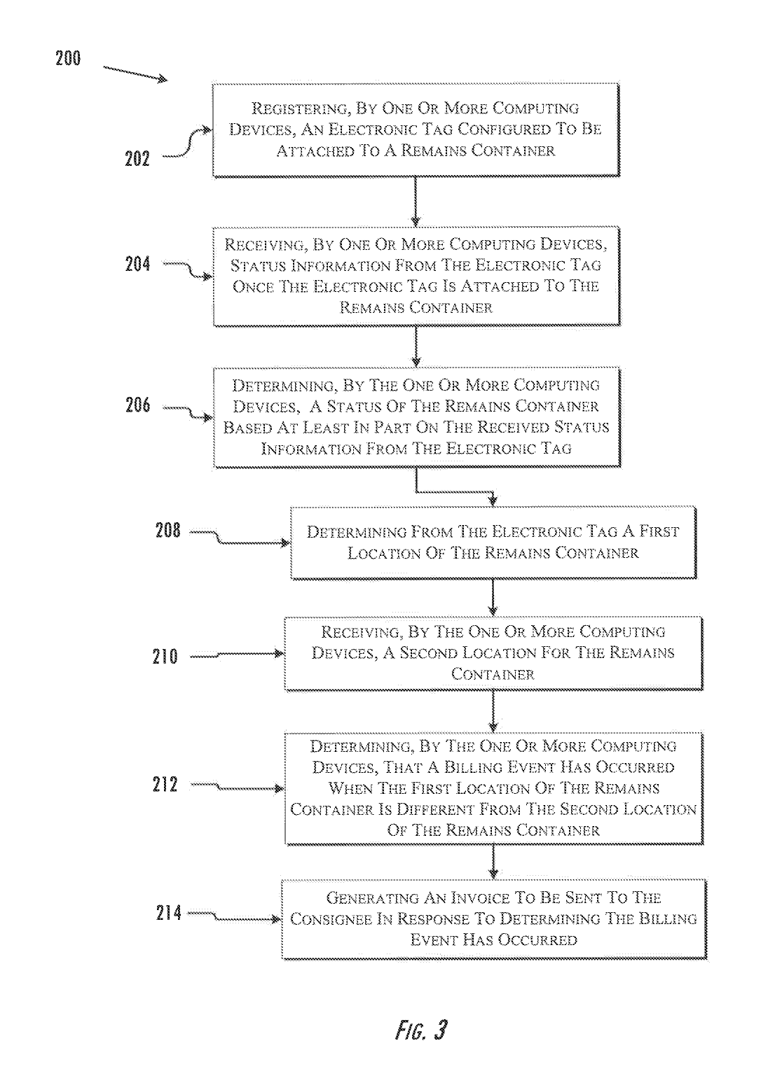

Referring now to FIG. 3, a computer-implemented method (200) for managing an inventory of remains containers in accordance with an exemplary aspect of the present disclosure is provided. The exemplary method of FIG. 3 may he used in conjunction with the exemplary system 100 described above with reference FIG. 2 and/or with the exemplary casket 10 described above with reference to FIG. 1.

The exemplary method (200) includes at (202) registering, by one or more computing devices, an electronic tag configured to be attached to a remains container. For example, in certain exemplary aspects, the user may enter a unique identification number or code of the electronic tag directly into a computing device. The one or more computing devices may include one or more processors, memory, and one or more user interface devices. Additionally, the one or more computing devices may be connected to a central server by one or more networks, such as a WAN or LAN.

The electronic tag may be attached to a remains container to be provided to a consignee and the remains container may subsequently be provided to the consignee with the electronic tag attached thereto. As discussed above with reference to FIG. 1, attaching the electronic tag to a remains container to he provided to the consignee may include any suitable means or method for ensuring the electronic tag is not easily separated from the remains container.

Moreover, the exemplary computer-implemented method (200) depicted in FIG. 3 also includes at (204) receiving, by the one or more computing devices, status information from the electronic tag once the electronic tag is attached to the remains container, and at (206) determining, by the one or more computing devices, the status of the remains container based at least in part on the received status information of the electronic tag. Alternatively, however, in other exemplary aspects, and as will be discussed in greater detail below, the method (200) may include determining, by the one or more computing devices, the status of the remains container based at least in part on a cessation of receipt of status information from the electronic tag.

Referring still to the exemplary aspect of FIG. 3, determining the status information of the remains container at (206) includes at (208) determining from the electronic tag a first location of the remains container, the first location being an actual location of the remains container. Additionally, determining the status of the remains container at (206) further includes at (210) receiving, by one or more computing devices, a second location for the remains container and at (212) determining, by the one or more computing devices, that a billing event has occurred when the first location of the remains container is different from the second location of the remains container. Notably, the second location may be an anticipated location for the electronic tag and remains container, such as, a central location of the consignee to whom the remains container is provided. More particularly, the anticipated location may be a location of a parlor and/or storage area of the consignee to whom the remains container is provided. Alternatively, however, the anticipated location may be a distance within a predetermined range from, e.g., a local hub in communication with the computing device. Accordingly, when the first location the remains container is different from the second location of the remains container, it may be indicative of the remains container having been moved from a central location the consignee.

Referring still to FIG. 3, the exemplary method (200) further includes at (214) generating an invoice to be sent to the consignee in response to determining the billing event has occurred at (212).

Notably, in certain exemplary aspects, the electronic tag attached to the remains container may be configured to utilize a communication network with a range of communication that will not allow the one or more computing devices to receive status information at (204) directly from the electronic tag from the location of the consignee. Accordingly, in certain exemplary aspects, the consignee may be provided with a local hub within a communication range of the electronic tags. The local hub may be capable of receiving status information from the electronic tags through one or more communications networks. Accordingly in such an exemplary aspect, receiving, by the one or more computing devices, status information from the electronic tag at (204) may include receiving status information from the electronic tag through a local hub.

It should be appreciated, however, that in other exemplary aspects, the exemplary method (200) may determine a billing event has occurred at (212) in any other suitable manner. For example, as briefly mentioned above, the exemplary method (200) may determine a billing event has occurred at (212) based on a lack of communication between the electronic tag and the computing device. More particularly, in such an exemplary aspect, the exemplary computer-implemented method (200) may include determining, by the one or more computing devices, a status of the remains container based at least in part on a cessation of received status information from the electronic tag. Such an exemplary method may further include determining, by the one or more computing devices, that a billing event has occurred when there is a cessation of received status information from the electronic tag. Notably, with such an exemplary method, determining that a billing event has occurred may be indicative of the remains container being buried.

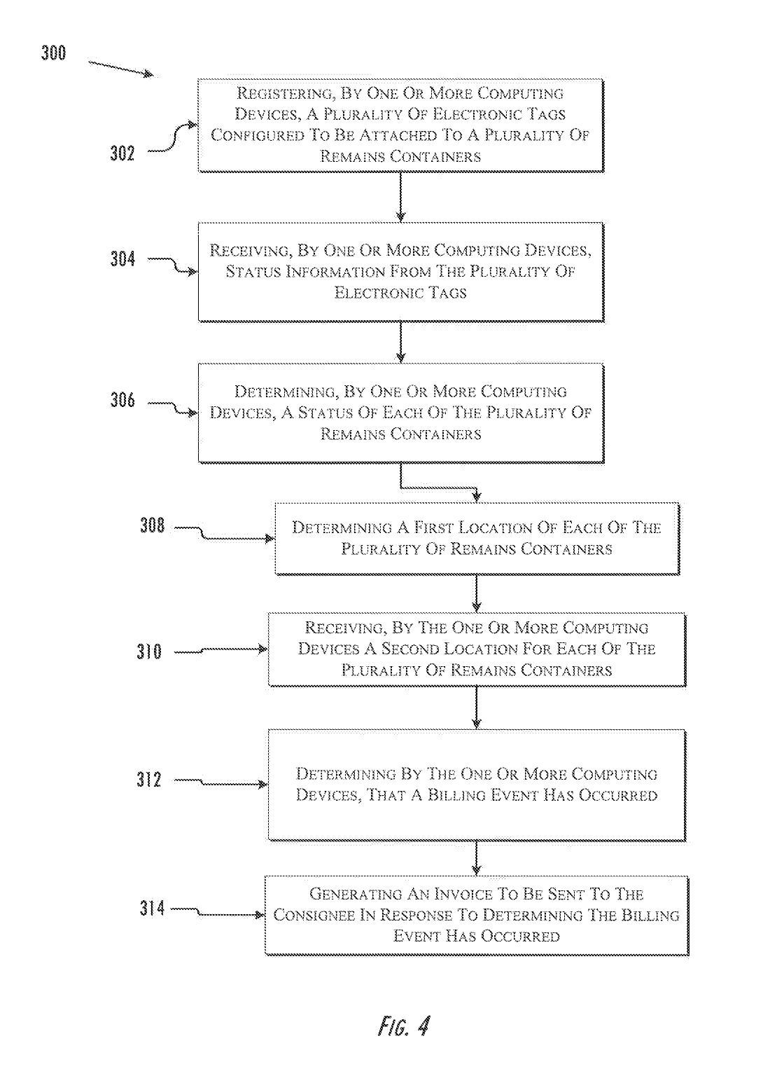

Referring now to FIG. 4 a computer-implemented method (300) is provided for managing an inventory of remains containers in accordance with another exemplary aspect of the present disclosure. The exemplary computer-implemented method (300) is similar to the exemplary computer-implemented method (200) of FIG. 3. More particularly, the exemplary computer-implemented method (300) applies certain concepts of the exemplary computer-implemented method (200) of FIG. 3 to a plurality of remains containers.

For example, the exemplary method (300) includes at (302) registering, by one or more computing devices, a plurality of electronic tags configured to be attached to the plurality of remains containers. The plurality of electronic tags may be attached to the plurality of remains containers, and the plurality of remains containers may be provided to one or more consignees. Exemplary method (300) further includes at (304) receiving, by the one or more computing devices, status information from the plurality of electronic tags and at (306) determining, by the one or more computing devices, a status of each of the plurality of remains containers based at least in part on the received status information from the plurality of electronic tags.

Moreover, referring still to the exemplary aspect of FIG. 4, determining the status of each of the plurality of remains containers at (306) includes at (308) determining a first location of each of the plurality of remains containers. The first location of each of the plurality of remains containers may be an actual location of each of the plurality of remains containers. Additionally, determining the status of each the remains containers at (306) further includes at (310) receiving, by the one or more computing devices, a second location for each of the plurality of remains containers. The second location for each of the plurality of remains containers may be anticipated location for each of the plurality of remains containers. Further, determining the status the remains containers at (306) may include determining at (312), by the one or more computing devices, that a billing event has occurred with respect to one of the plurality of remains containers when the first location of a remains container is not equal to the second location of the respective remains container, and at (314) generating an invoice to be sent to the consignee in response to determining at (312) that the billing event has occurred.

Although not depicted, it should be appreciated that other exemplary aspects of the method (300) of FIG. 4 may additionally or alternatively apply other aspects of the exemplary method (200) to the plurality of remains containers referenced in the exemplary method (300) of FIG, 4. For example, in certain exemplary aspects, the exemplary method (300) of FIG. 4 may additionally, or alternatively, include determining by the one or more computing devices, that a billing event has occurred in response to a cessation of receive status information from one or more of the plurality of electronic tags.

Moreover, the exemplary computer implemented method (300) of FIG. 4 may allow for the generation of certain status reports and/or billing reports regarding the plurality of remains containers. For example, in response to a user input to the computing device, the computing device may communicate with the plurality of electronic tags attached to the plurality of remains containers, and the computing device may determine certain information regarding each of the remains containers. For example, the computing device may provide a status of each of the remains containers. The status of each of the remains containers may include, for example, whether or not the electronic tag attached to the respective remains container is actively communicating with the computing device, actual locations of the remains containers, and/or whether the actual locations of the remains containers are equal to the respective anticipated locations. Additionally, or alternatively, the exemplary method (300) of FIG. 4 may allow a user to conduct a search using the computing device for one or more remains container(s) meeting certain criteria. For example, in certain exemplary aspects, providing information regarding an electronic tag may include providing specific information about the remains container to which the electronic tag is being attached. More specifically, providing information regarding an electronic tag may include providing the model number, make, color, etc, of the remains container to which the electronic tag is being attached. Such an exemplary aspect may allow a user to conduct a search using the computing device for a remains container meeting certain requirements within a geographic area. For example, if the user needed to get a specific type of casket to a customer at a certain location, the user may conduct a search for caskets meeting the requirements closest to the geographic area of the customer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computer-implemented method for managing an inventory of remains containers comprising:
registering, by one or more computing devices, an electronic tag configured to be attached to a remains container;
receiving, by one or more computing devices, status information from the electronic tag once the electronic tag is attached to the remains container; and
determining, by one or more computing devices, a status of the remains container based at least in part on the received status information from the electronic tag or a cessation of received status information from the electronic tag.

2. The computer-implemented method of claim 1, wherein the remains container is a casket or an urn.

3. The computer-implemented method of claim 1, wherein determining the status of the remains container includes determining from the electronic tag a first location of the remains container, the first location being an actual location of the remains container.

4. The computer-implemented method of claim 3, wherein determining the status of the remains container further comprises:
receiving, by one or more computing devices, a second location for the remains container; and
determining, by one or more computing devices, that a billing event has occurred when the first location of the remains container is different from the second location of the remains container.

5. The computer-implemented method of claim 4, further comprising:
generating an invoice to he sent to the consignee in response to determining the billing event has occurred.

6. The computer-implemented method of claim 1, further comprising:
determining, by one or more computing devices, that a billing even has occurred when there is a cessation of received status information from the electronic tag.

7. The computer-implemented method of claim 6, wherein determining that a billing event has occurred is indicative of the remains container being buried.

8. The computer-implemented method of claim 1, wherein the electronic tag is configured to be attached to the remains container at a location that is hidden from view.

9. The computer-implemented method of claim 1, further comprising:
registering, by one or more computing devices, a plurality of electronic tags configured to be attached to a plurality of remains containers;
receiving, by one or more computing devices, status information from the of electronic tags;
determining, by one or more computing devices, a status of each of the plurality of remains containers based at least in part on the received status information from one or more of the plurality the electronic tags, a cessation of received status information from one or more of the plurality of electronic tags, or both.

10. The method of claim 9, wherein determining the status of each of the plurality of remains containers includes determining a first location of each of the plurality of remains containers, the first location of each of the plurality of remains containers being an actual location of each of the plurality of remains containers.

11. The method of claim 1, wherein the electronic tag includes a Global Positioning System receiver.

12. The method of claim 1, wherein receiving status information from the electronic tag includes receiving status information from the electronic tag through a local hub.

13. A computer-implemented method for managing an inventory of remains containers comprising:
registering, by one or more computing devices, an electronic tag configured to be attached to a remains container;
receiving, by one or more computing devices, status information from the electronic tag once the electronic, tag is attached to a remains container;
determining, by one or more computing devices, a cessation of received status information from the electronic tag; and
determining, by one or more computing devices, a billing event has occurred in response to the determination of a cessation of received status information from the electronic tag.

14. The method of claim 13, wherein the remains container is a casket or an urn.

15. The method of claim 13, wherein the remains container is a casket, and wherein determining a cessation of received status information from the electronic tag indicates the casket has been buried.

16. The method of claim 13, further comprising:
generating an invoice to be sent to the consignee in response to determining the billing event has occurred.

17. The method of claim 13, wherein the electronic tag is configured to be attached to the remains container at a location that is hidden from view.

18. The method of claim 13, wherein the electronic tag includes a Global Positioning System receiver.

19. The method of claim 13, wherein receiving status information from the electronic tag includes receiving status information from the electronic tag through a local hub.
